(19) United States
(12) Patent Application Publication
(10) Pub. No.: US 2009/0317777 A1
(43) Pub. Date: Dec. 24, 2009

(54) Educational Systems and Methods for Learning How to Spell

(75) Inventors: Leslie Melville Kasper, Alpharetta, GA (US); Olivia Melville Kasper, Alpharetta, GA (US); McKenzie Eleanor Kasper, Alpharetta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LogicRules, Alpharetta, GA (US)

(21) Appl. No.: 12/437,675

(22) Filed: May 8, 2009

Related U.S. Application Data
(60) Provisional application No. 61/073,475, filed on Jun. 18, 2008.

(51) Int. Cl. G09B 19/00; G09B 5/00; B43L 1/00

(52) U.S. Cl. 434/169; 434/167; 434/408

(57) ABSTRACT

Educational systems and methods for learning how to spell are provided. In this regard, a representative system includes: a working surface including a representation of a hand having five fingers; five sets of vowels “a”, “e”, “i”, “o” and “u” depicted at the working surface, each of the sets being associated with a corresponding one of the fingers; and five spelling locations depicted at the working surface, each of the locations being associated with a corresponding one of the fingers.

### CROSS REFERENCE TO RELATED APPLICATION

This utility application claims the benefit of and priority to U.S. Provisional Patent Application Ser. No. 61/073,475, filed Jun. 18, 2008, the entirety of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Technical Field

The disclosure generally relates to educational tools and learning aids.

2. Description of the Related Art

Common teaching techniques for improving vocabulary and spelling tend to focus on rote memorization. Although meeting with varying levels of success, these techniques are not well suited for all students.

### SUMMARY

Educational systems and methods for learning how to spell are provided. In this regard, an exemplary embodiment of a system for learning how to spell a word comprises: a working surface including a representation of a hand having five fingers; five sets of vowels “a”, “e”, “i”, “o” and “u” depicted at the working surface, each of the sets being associated with a corresponding one of the fingers; and five spelling locations depicted at the working surface, each of the locations being associated with a corresponding one of the fingers.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram depicting an exemplary embodiment of an educational system.

FIG. 2 is a schematic diagram depicting another exemplary embodiment of an educational system.

FIG. 3 is a schematic diagram depicting another exemplary embodiment of an educational system.

FIG. 4 is a flowchart depicting functionality (method steps) that may be performed by and/or using the embodiment of FIG. 3.

FIG. 5 is a schematic diagram depicting a first working surface of another exemplary embodiment of an educational system.

FIG. 6 is a schematic diagram depicting a second working surface of the embodiment of FIG. 5.

### DETAILED DESCRIPTION

Educational systems and methods for learning how to spell are provided, several exemplary embodiments of which will be described in detail. In this regard, various embodiments generally involve breaking down words into syllables and directing students to focus on hearing the syllables before attempting to spell the words. Each syllable is spelled and then the entire word is spelled by connecting the syllables. This process promotes vowel recognition, consonant recognition and correct spelling. Such a process also tends to reinforce the concept of breaking a word down into the constituent parts of root, prefix and/or suffix, in contrast to mere rote memorization of the spelling of an entire word.

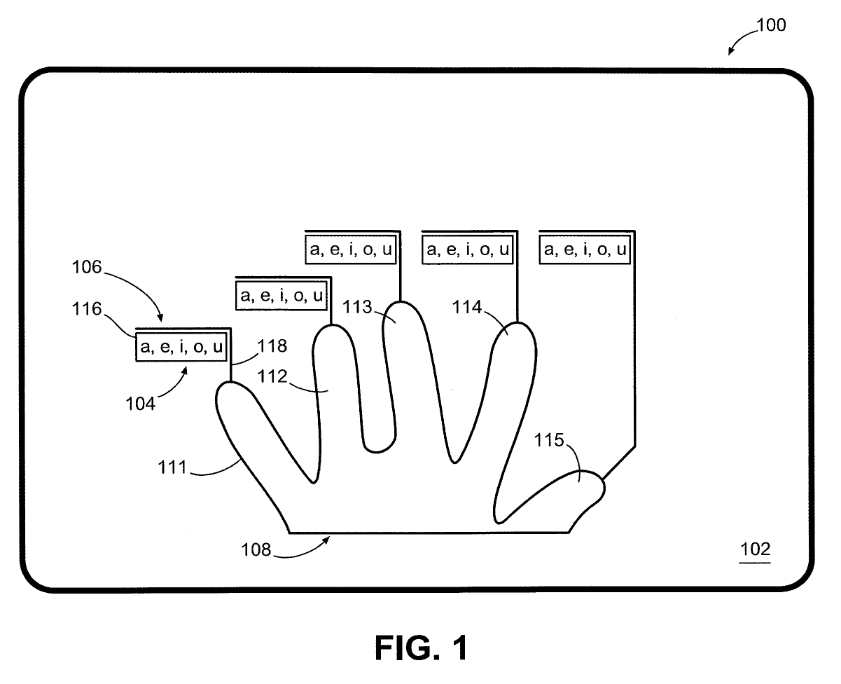

Referring to the schematic diagram of FIG. 1, an exemplary embodiment of an educational system is depicted. As shown in FIG. 1, system 100 includes a working surface 102, sets of vowels (e.g., set 104), and spelling locations (e.g., location 106). The working surface includes a representation of a hand 108 with five outstretched fingers (111-115). In this embodiment, the hand is a left hand. In some embodiments, such as when the working surface is provided as a two-sided placard (e.g., a laminated card), one side incorporates a representation of a left hand while the other side incorporates a representation of a right hand.

Five sets of vowels “a”, “e”, “i”, “o” and “u” are included, with each of the sets being associated with a corresponding one of the fingers. For instance, set 104 is associated with finger 111. In this embodiment, each set of vowels appears in a separate box (e.g., box 116).

Five spelling locations also are provided, with each of the locations being associated with a corresponding one of the fingers. By way of example, location 106 is associated with finger 111. In this embodiment, association of each location with a corresponding finger is presented by a line (e.g., line 118) interconnecting the finger with a corresponding location, although in other embodiments, various alternative or additional forms of association can be used (e.g., proximity, color, etc).

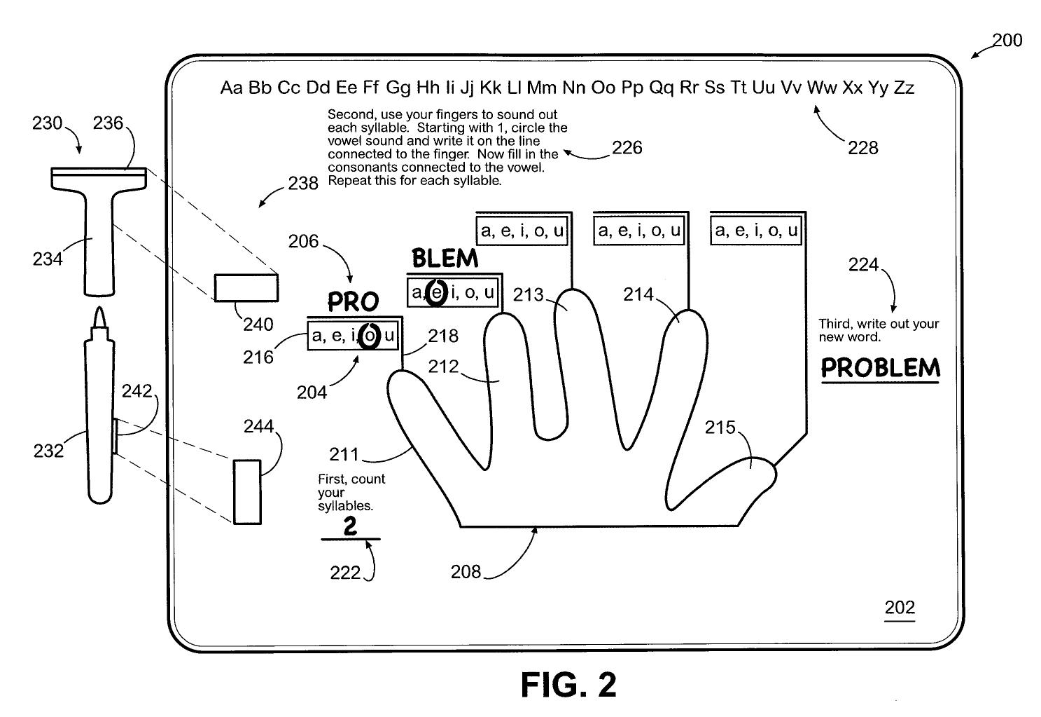

FIG. 2 is a schematic diagram depicting another exemplary embodiment of an educational system. As shown in FIG. 2, system 200 includes a working surface 202, sets of vowels (e.g., set 204), and spelling locations (e.g., location 206). The working surface includes a representation of a left hand 208 with five outstretched fingers (211-215).

Five sets of vowels “a”, “e”, “i”, “o” and “u” are included, with each of the sets being associated with a corresponding one of the fingers. For instance, set 204 is associated with finger 211. Each set of vowels appears in a separate box. For instance, set 204 is positioned within box 216.

Five spelling locations also are provided, with each of the locations being associated with a corresponding one of the fingers. By way of example, location 206 is associated with finger 211. Lines interconnect each finger with a corresponding location. For example, line 218 interconnects finger 211 and location 206.

Also included is a syllable count location 222 (at which the number of syllables of a given word can be written), a word location 224 (at which a completed word can be written) and, instructions 226. A row 228 of upper and lower case letters provided along an edge of this embodiment for reference.

In the embodiment of FIG. 2, working surface 202 is comparable in size to that of a standard placemat. Although not shown in FIG. 2, system 200 includes a second working surface located on the side opposite surface 202. Specifically, the second working surface includes features similar to those depicted on working surface 202 with the exception of the hand being a right hand.

Working surface 202 is provided by a cover (e.g., a transparent lamination) that can be written on with an erasable writing instrument 230. In this case, the writing instrument includes a felt tip pen 232 with erasable ink. A cap 234 of the writing instrument includes a pad 236 for erasing ink from the transparent cover.

In this embodiment, a fastening assembly 238 is used to selectively secure the writing instrument to the working surface. In particular, the fastening assembly incorporates a patch 240 of hook material attached to the working surface. The pad of the writing instrument incorporates a material (e.g., felt) that attaches to the hook material of the patch. Although optional, a second attachment is used in FIG. 2, including loop material 242 on the pen and a second patch 244 of hook material on the working surface. In other embodiments, various other forms of attachment can be used.

In operation, a student places one of his/her hands on the “hand” of the working surface—the other hand of the student will be used to write on the working surface with the writing instrument. The student is then provided with a word to spell. Typically, this is done verbally by an instructor, although other embodiments (such as described later) may use a form of computer or recorded speech. In this representative example, the word to be spelled by the student is “problem.”

After being informed of the word, the student is to determine the number of syllables and write the determined number in syllable count location 222. As shown in FIG. 2, the student has written “2” in syllable count location 222, as the word “problem” has two syllables. Note that finger counting can be used to determine the number of syllables.

Next, the student uses the first set of vowels to identify the vowel associated with the first of the two syllables in the word “problem.” In this case, the student has correctly identified the vowel “o” as being associated with the first syllable “pro” and has circled the “o” within the first set 204 of vowels.

The student then attempts to identify the consonants associated with the first syllable. This can be accomplished by the student saying the first syllable aloud and then writing the entire first syllable in spelling location 206. As shown in FIG. 2, the student wrote “pro” in spelling location 206.

Repeating the process for the second syllable “blem” results in the vowel “e” being circled in set 250, and “blem” being written in spelling location 252. Rewriting both the first and second syllables together in word location 224 results in the word “problem” being written properly.

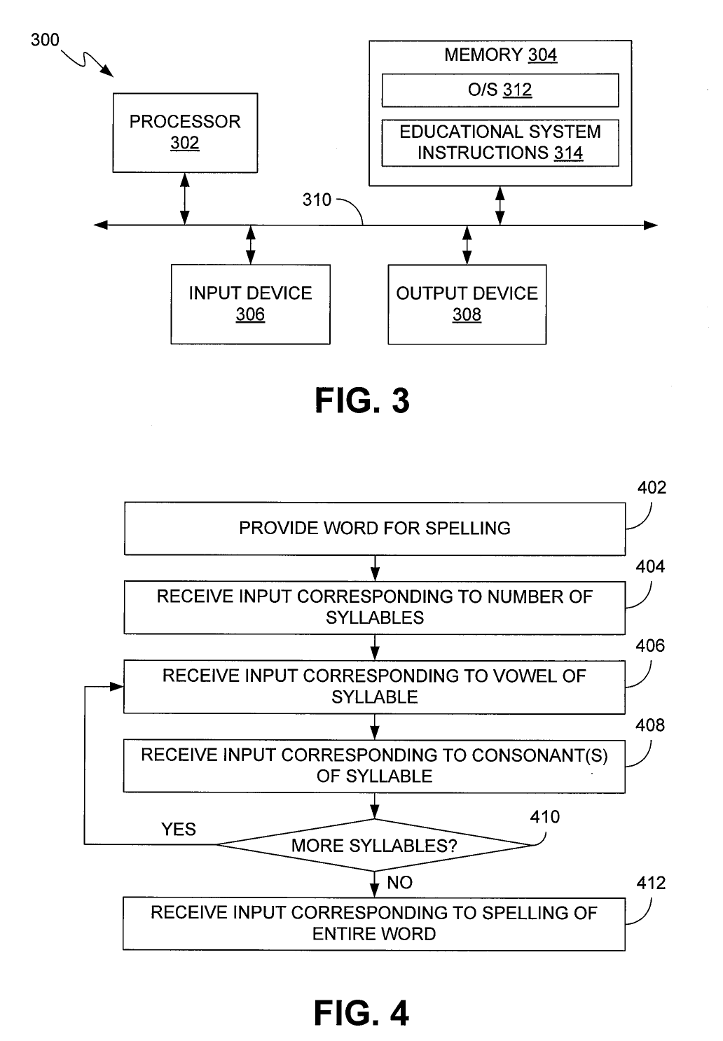

It should be noted that various functionality can be implemented in hardware and/or software. In this regard, FIG. 3 is a schematic diagram depicting another exemplary embodiment of an educational system. As shown in FIG. 3, system 300 includes a computing device that incorporates a processor 302, a memory 304, an input device 306, and output device 308 and a local interface 310, which facilitates communication among the components. Notably, memory 304 includes an operation system (O/S) 312 and educational system instructions 314.

The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The input devices that may be coupled to system may include, for example but not limited to, a keyboard, mouse, scanner, microphone, camera, proximity device, etc. Further, the output devices may also include, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

FIG. 4 is a flowchart depicting functionality (method steps) that may be performed by and/or using the embodiment of FIG. 3. For instance, executable program code contained in educational system instructions 314 can facilitate the functionality presented by the flowchart of FIG. 4.

As shown in FIG. 4, the functionality involves providing a word for spelling (block 402). In some embodiments, this may involve providing the word in audible form (such as by using a speaker of the computing device) or by an instructor reading the word from a printed sheet provided from a database of the system, for example. In block 404, input corresponding to the number of syllables in the word is received. In some embodiments, this may involve receiving an input from a keyboard, while, in others, a touch screen of a display can be used, for example. In block 406, input corresponding to a vowel associated with a first of the syllables is received. Then, in block 408, input corresponding to consonants of the first syllable is received. Thereafter, such as depicted in block 410, a determination is made as to whether there are any more syllables in the word. If there are, the process returns to block 406 and proceeds as previously described until all the syllables have been analyzed. However, if there are no more syllables, the process proceeds to block 412, in which input corresponding to the spelling of the entire word is received.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the functionality described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” contains, stores, communicates, propagates and/or transports the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of a computer-readable medium include a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical).

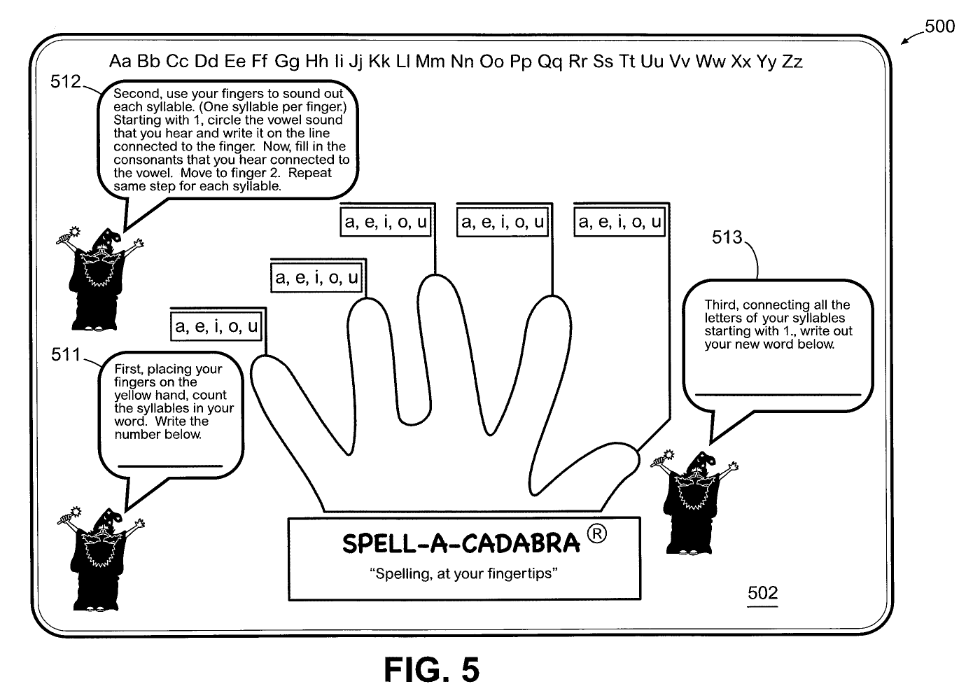

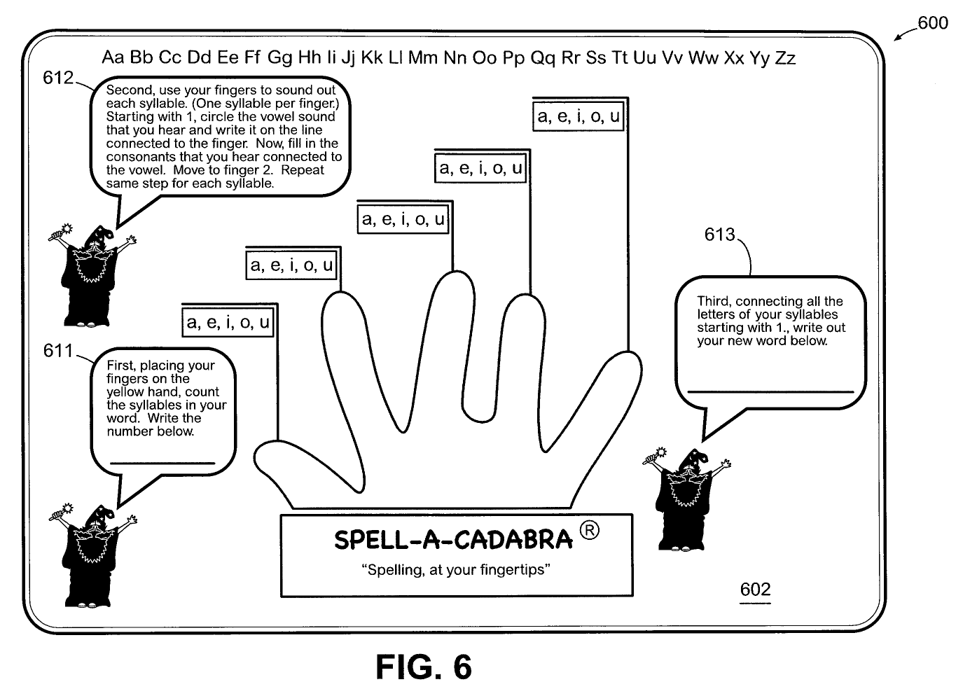

FIGS. 5 and 6 are schematic diagrams depicting first and second working surfaces of another exemplary embodiment of an educational system. It should be noted that due to the number of similarities between the current embodiment (FIGS. 5 and 6) and other embodiments described previously, various aspects of the current embodiment will not be described again here.

As shown in FIGS. 5 and 6, system 500 includes working surfaces that are formed as opposing sides of a placard. Specifically, the placard is a laminated sheet with graphics on the opposing sides. As shown in FIG. 5, working surface 502 includes a graphical representation of a left hand, whereas (in FIG. 6) working surface 602 includes a graphical representation of a right hand.

An integrated tutorial is provided on the working surfaces as step-by-step instructions. In this embodiment, a set of three instructional steps (511, 512 and 513 on surface 502, and 611, 612 and 613 on surface 602) are used.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

1. An educational system for learning how to spell a word comprising:
a working surface including a representation of a hand having five fingers;
five sets of vowels “a”, “e”, “i”, “o” and “u” depicted at the working surface, each of the sets being associated with a corresponding one of the fingers; and
five spelling locations depicted at the working surface, each of the locations being associated with a corresponding one of the fingers.

2. The system of claim 1, wherein the working surface is a laminated sheet.

3. The system of claim 2, further comprising a writing instrument operative to mark the working surface such that syllables of a word can be written in the spelling locations.

4. The system of claim 3, wherein:
the writing instrument comprises an erasable marker; and
the working surface comprises a material from which ink from the marker can be erased.

5. The system of claim 4, wherein the writing instrument further comprises a cap for the marker, the cover having a pad for erasing the ink.

6. The system of claim 5, further comprising a fastening assembly operative to selectively secure the writing instrument with respect to the working surface.

7. The system of claim 6, wherein:
the fastening assembly comprises a patch of hook material attached to the working surface; and
the pad of the writing instrument is operative to attach to the patch.

8. The system of claim 1, wherein:
the system further comprises a computing device having a display;
the working surface is provided by the display.

9. The system of claim 8, wherein the display is touch sensitive such that vowels of the sets of vowels are independently actuatable responsive to touching corresponding ones of the vowels.

10. The system of claim 8, wherein the display is operative to display syllables of a word in corresponding ones of the spelling locations responsive to user input to the computing device.

11. The system of claim 8, wherein the computing device is operative to provide a word to the user in audible form such that the user is able to determine spelling of the word.

12. The system of claim 1, wherein:
the system further comprises a word location depicted at the working surface;
the spelling locations receive text associated with syllables of a word such that each syllable of the word has a corresponding one of the spelling locations; and
the word location receives text associated with each of the spelling locations such that the word is spelled completely at the word location.

13. An educational method for learning how to spell a word comprising using the system of claim 1.

14. The method of claim 13, wherein using the system comprises:
counting syllables of the word;
designating, on the working surface, a vowel of a first of the sets of vowels as being associated with a first syllable of the word;
determining any consonants associated with the first syllable; and
indicating letters associated with the first syllable at the first spelling location.

15. An educational method for learning how to spell comprising using the system of claim 8.
